(19) United States
(12) Patent Application Publication
(10) Pub. No.: US 2005/0069600 A1
(43) Pub. Date: Mar. 31, 2005

(54) Platen for improved molding

(76) Inventors: Stephen K. Scolamiero, Bristol, RI (US); Thomas E. Moore, Bristol, RI (US); Paul A. Furze, Tiverton, RI (US); Gary J. Brune, Lakeville, MA (US); Manuel D. Goncalves, Acushnet, MA (US)

Correspondence Address: SWIDLER BERLIN SHEREFF FRIEDMAN, LLP, 3000 K STREET, NW, BOX IP, WASHINGTON, DC, 20007, US

(21) Appl. No.: 10/670,459

(22) Filed: Sep. 26, 2003

(51) Int. Cl. B29C 43/02

(52) U.S. Cl. 425/149; 425/150; 425/167; 425/407; 425/408

(57) ABSTRACT

A molding machine having a mold including upper and lower mold plates, an upper heat transfer platen connected to the upper mold plate, and a lower heat transfer platen connected to the lower mold plate. Each mold plate contains mold cavities. When the mold plates are aligned and abutted, mold locations from the upper and lower mold plates cooperate to form mold volumes. Each of the heat transfer platens contain two series of independent channels for supplying heat transfer media to control the temperature of the material being molded. Each series of channels includes feeder channels and transverse channels. All of the transverse channels of a heat transfer platen are substantially coplanar and parallel. A plurality of adapters supplies heat transfer media to the channels. A ram is connected to one of the heat transfer platens. A control system controls movement of the ram. A protection device continuously monitors the operation of the molding machine. The protection device monitors the movement and position of the ram and the pressure exerted by the ram. The control system contains a plurality of triggers to ensure the molding machine is operated under predetermined conditions.

### BACKGROUND OF THE INVENTION

1. Field of the Invention

The present invention is directed to a molding machine. More specifically, the present invention is directed to a molding machine including a platen used in compression molding presses that includes independent channels so multiple heat transfer sources can be used.

2. Description of the Related Art

Golf balls are conventionally made by molding a cover around a core. The core may be wound or solid. A wound core typically comprises elastic thread wound about a solid or liquid center. Solid cores typically comprise a single solid piece center or a solid center covered by one or more mantle or boundary layers of material. Solid cores are typically formed by compression molding a slug of a predetermined amount of material.

Known core materials include thermoset materials, such as rubber, styrene butadiene, polybutadiene, isoprene, polyisoprene, trans-isoprene, as well as thermoplastics, such as ionomer resins, polyamides or polyesters, and thermoplastic and thermoset polyurethane elastomers, and any mixture thereof. Polyurea compositions may also be used to form cores.

A core may also include other conventional materials, such as compositions including a base rubber, a crosslinking agent, and a density adjusting filler. The base rubber may include natural or synthetic rubbers, as well as any combination thereof. The core may also include one or more cis-to-trans catalysts and a free radical source, as well as a cis-to-trans catalyst accelerator and crosslinking agent.

The core may also include a filler. Fillers typically include processing aids or compounds to affect rheological and mixing properties, the specific gravity (i.e., density-modifying fillers), the modulus, the tear strength, reinforcement, and the like. The fillers are generally inorganic, and suitable fillers include numerous metals (including metal powders) or metal oxides, such as zinc oxide and tin oxide, as well as barium sulfate, zinc sulfate, calcium carbonate, barium carbonate, clay, tungsten, tungsten carbide, an array of silicas, and mixtures thereof. Fillers may also include various foaming agents or blowing agents which may be readily selected by one of ordinary skill in the art. Foamed polymer blends may be formed by blending ceramic or glass microspheres with polymer material. Polymeric, ceramic, metal, and glass microspheres may be solid or hollow, and filled or unfilled. Fillers are also typically added to modify the density thereof to conform to uniform golf ball standards.

Additional materials conventionally included in golf ball compositions may be present in the core. These additional materials include, but are not limited to, density-adjusting fillers, coloring agents, reaction enhancers, whitening agents, UV absorbers, hindered amine light stabilizers, defoaming agents, processing aids, and other conventional additives. Stabilizers, softening agents, plasticizers, including internal and external plasticizers, impact modifiers, foaming agents, excipients, reinforcing materials, and compatibilizers can also be added.

Golf ball covers may be injection molded, compression molded, or cast over the core. Forming a cover typically requires a mold having at least one pair of mold cavities; e.g., a first mold cavity and a second mold cavity, that matingly form a spherical recess. In addition, a mold may include more than one mold cavity pair. An exemplary compression molding process uses a mold assembly comprising a pair of opposed mold plates, each of which contains one or more individual golf ball half molds or mold cups within a mold frame. The cover material is preformed into half-shells, which are placed, respectively, into each of a pair of compression mold cavities. The core is placed between the cover material half-shells and the mold is closed. The core and cover combination is then exposed to heat and pressure, which cause the cover half-shells to melt and combine to form a full cover. The mold is then cooled to cool the cover stock, thereby solidifying it before the mold is reopened.

Compression molding is also frequently used to create cores for golf balls, including multilayer cores. An exemplary embodiment of compression molding a core having a center and one layer over the center is disclosed in U.S. Pat. No. 6,096,255. A mold assembly comprising a lower or bottom mold plate, an upper or top mold plate, and a center mold plate is provided. The bottom and top mold plates include a plurality of mating cavities that form spheres, which are sized according to the desired core size (the center plus the layer). The center mold plate includes a plurality of protrusions on opposite sides thereof for corresponding with the cavities of the top and bottom mold plates. The protrusions are hemispheres that are substantially the same size as half of the ball center.

First, the core outer layer material is placed in the cavities of the bottom and top mold plate. Then the center mold plate is moved into alignment with the top mold plate such that the protrusions are located in alignment or coaxially with the cavities. However, the center mold plate is positioned over the top mold plate at such a height that the layer material is only compressed enough to hold the material in place. Then the center mold plate and the top mold plate are moved into alignment with the bottom mold plate such that the protrusions and the cavities are all in alignment. Again, the center plate is spaced from the bottom mold plate such that the material in the bottom mold plate cavities is only slightly compressed. Thus, a folded assembly is formed.

Once the mold assembly is in position, the folded assembly is placed into a press, heated and compressed. The folded assembly is compressed to a pressure sufficient enough to form hemispheres from the layer material.

After the outer layer material, e.g. polybutadiene material, has been preformed into hemispheres, the mold assembly is removed from the press and the bottom mold plate, top mold plate, and the center mold plate are moved out of alignment. Then the ball centers are placed within the hemispherical cups located in the top mold plate. The bottom mold plate is moved into alignment with the top mold plate such that the outer layer hemispherical cups form a sphere around the ball centers. Then the top and bottom mold plates are placed back into the press, heated, and compressed again. This time, the bottom and top mold plates are heated to a temperature above the cure activation temperature of the cups.

Standard compression molding techniques used today in the manufacture of golf balls have one or more channels running between or along adjacent rows of mold cavities in the mold frame. These channels can be located within the mold frame or in a separate heating/cooling device, such as a heat transfer platen. Heating or cooling fluid as required is run through these channels in order to heat and cool the mold frame which in turn heats or cools the individual mold cavities to change the temperature of the cover of the balls. See e.g. U.S. Pat. Nos. 4,508,309 and 4,757,972.

The covers of today's golf balls are made from a variety of materials, such as balata, SURLYN®, and IOTEK®. Balata is a natural or synthetic trans-polyisoprene rubber. Balata covered balls are favored by more highly skilled golfers because the softness of the cover allows the player to achieve spin rates sufficient to more precisely control ball direction and distance, particularly on shorter shots. Balata-covered balls, however, are easily damaged, and thus lack the durability required by the average golfer. Accordingly, alternative cover compositions have been developed in an attempt to provide balls with spin rates and a feel approaching those of balata-covered balls, while also providing higher durability and overall distance.

Ionomer resins have, to a large extent, replaced balata as a cover material. Chemically, ionomer resins are a copolymer of an olefin and an α,β-ethylenically-unsaturated carboxylic acid having 10 to 90 percent of the carboxylic acid groups neutralized by a metal ion, as disclosed in U.S. Pat. No. 3,264,272. Commercially available ionomer resins include, for example, copolymers of ethylene and methacrylic or acrylic acid, neutralized with metal salts. Examples of commercially available ionomer resins include, but are not limited to, SURLYN® from DuPont de Nemours and Company, and ESCOR® and IOTEK® from Exxon Corporation. These ionomer resins are distinguished by the type of metal ion, the amount of acid, and the degree of neutralization. However, while ionomer-covered golf balls possess virtually cut-proof covers, the spin and feel are inferior compared to balata-covered balls.

Polyurethanes have also been recognized as useful materials for golf ball covers. The resulting golf balls are durable and, unlike ionomer-covered golf balls, polyurethane golf ball covers can be formulated to possess the soft “feel” of balata-covered golf balls. U.S. Pat. No. 4,123,061 teaches a golf ball made from a polyurethane prepolymer formed of polyether with diisocyanate that is cured with either a polyol or an amine-type curing agent. U.S. Pat. No. 5,334,673 discloses the use of two categories of polyurethane available on the market, i.e., thermoset and thermoplastic polyurethanes, for forming golf ball covers and, in particular, thermoset polyurethane-covered golf balls made from a composition of polyurethane prepolymer and a slow-reacting amine curing agent, and/or a difunctional glycol.

Polyureas have also been proposed as cover materials for golf balls. For instance, U.S. Pat. No. 5,484,870 discloses a polyurea composition comprising the reaction product of an organic diisocyanate and an organic amine, each having at least two functional groups. Once these two ingredients are combined, the polyurea is formed, and thus the ability to vary the physical properties of the composition is limited.

It has been found that precise control of the temperatures and pressures in and around the mold cavities is essential to obtain proper conformation of molded golf balls. What is needed is an improved compression molding machine.

### SUMMARY OF THE INVENTION

The present invention is directed to a molding machine. The molding machine includes a mold having an upper mold plate and a lower mold plate. Each of the mold plates has a plurality of cavities or voids therein. When the mold plates are aligned and abutted, corresponding voids from the mold plates cooperate to form a plurality of mold volumes.

The molding machine includes an upper heat transfer platen coupled to the upper mold plate and a lower heat transfer platen coupled to the lower mold plate. Each of the heat transfer platens has two series of independent and separate channels. Each series of channels includes feeder channels that run along opposing edges of the respective platen, and transverse channels that run between or connect the feeder channels. The two series of transverse channels in either of the platens are vertically offset by a maximum of about one times a diameter of said first plurality of transverse channels. Preferably, the two series of transverse channels in each of the platens are substantially coplanar. Furthermore, the transverse channels of any one series are relatively substantially parallel, and all of the transverse channels within one platen are relatively substantially parallel.

The molding machine includes a plurality of adapters coupled to ends of the feeder channels. Each of the adapters contains two orifices for independently connecting two heat transfer media to their respective feeder channels. The two heat transfer media are selected from a group consisting of steam, electrical heaters, water, oil, air, and the like. The two heat transfer media may include a medium to add heat and a medium to remove heat.

The molding machine also includes a ram coupled to the lower heat transfer platen and a plurality of thermal insulation plates. Some of the thermal insulation plates are intermediate the ram and the lower heat transfer platen. Movement of the ram is dictated by a control system. The control system may be part of an optional mold protection device that monitors the operation of the molding machine. The mold protection device includes a linear measurement device and a pressure measurement device. The linear measurement device measures the position of the ram, and the pressure measurement device measures the pressure exerted by the ram. The mold protection device includes a controller coupled to the measurement devices.

The controller may contain a plurality of programmable triggers to ensure the molding machine is operated in a safe manner. Engagement of some of the variable triggers disengages the ram, which returns to the withdrawn position. The triggers are based on measurements from the linear measurement device and/or the pressure measurement device. One trigger may be used for transitioning between a first ram speed and a second ram speed, the first ram speed being faster than the second ram speed. Another trigger may be used for disengaging the ram if a measurement from the pressure measurement device exceeds a predetermined value.

Another trigger may be used for transitioning between a relatively low pressure limit and a relatively high pressure limit. A second trigger may used with this trigger for disengaging the ram if a measurement from the pressure measurement device exceeds the relatively high pressure limit. A third trigger may be used for transitioning between a relatively high pressure limit and a relatively low pressure limit, and a fourth trigger may be used for disengaging the ram if a measurement from the pressure measurement device exceeds the relatively low pressure limit.

Another trigger may be used for limiting the maximum extension of the ram. The ram is disengaged if this trigger is tripped.

The protection system is operatively coupled to the ram and controls movement of the ram. The protection system can extend the ram at a plurality of speeds. A first speed may be used for moving the ram from a withdrawn position and a second speed may be used for moving the ram into a molding position, where the first speed is faster than the second speed. Exemplary speed values include about one inch per second for first speed and about one inch per minute for the second speed.

### DESCRIPTION OF THE DRAWINGS

The present invention is described with reference to the accompanying drawings, in which like reference characters reference like elements, and wherein:

FIG. 1 shows a side view of a molding machine of the present invention;

FIG. 2 shows a top view of a mold of the molding machine of FIG. 1;

FIG. 2A shows a partial side, cross-sectional view of the mold plates of the molding machine of FIG. 1 in a closed position;

FIG. 3 shows a top view of a thermal platen of the molding machine of FIG. 1;

FIG. 4 shows a front sectional view of an adapter of the molding machine of FIG. 1;

FIG. 5 shows a superposition of the mold of FIG. 2 on the thermal platen of FIG. 3;

FIG. 6 shows a side view of an adapter of the molding machine of FIG. 1; and

FIG. 7 shows a mold protection device installed on the molding machine of FIG. 1.

### DETAILED DESCRIPTION OF THE INVENTION

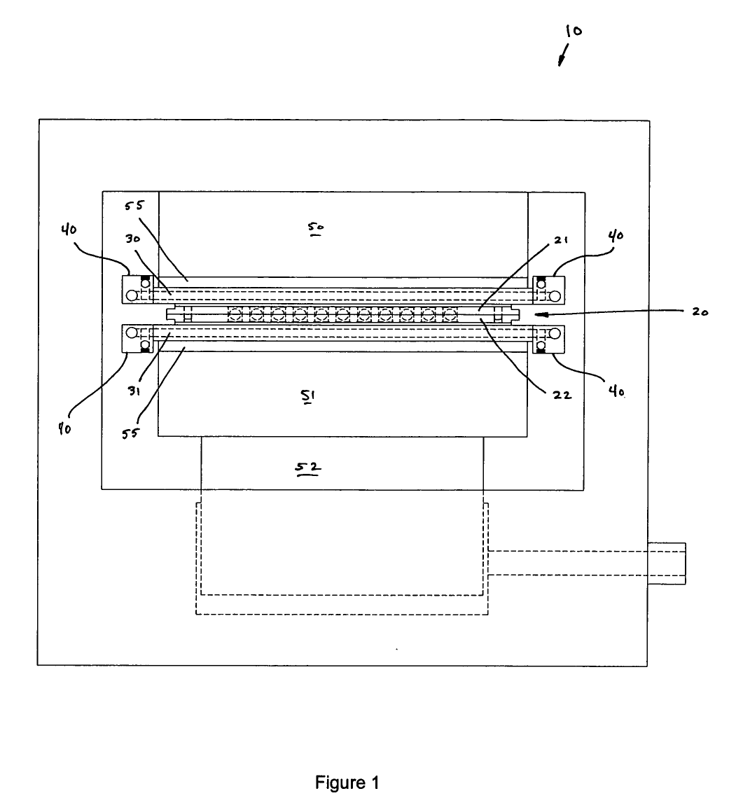

FIG. 1 shows a side view of a molding machine 10 of the present invention. Molding machine 10 includes a mold 20, heat transfer platens 30 and 31, a plurality of adapters 40, a plurality of thermal insulation plates 55, a press frame or head 50, a moving press platen 51, and a ram or piston 52.

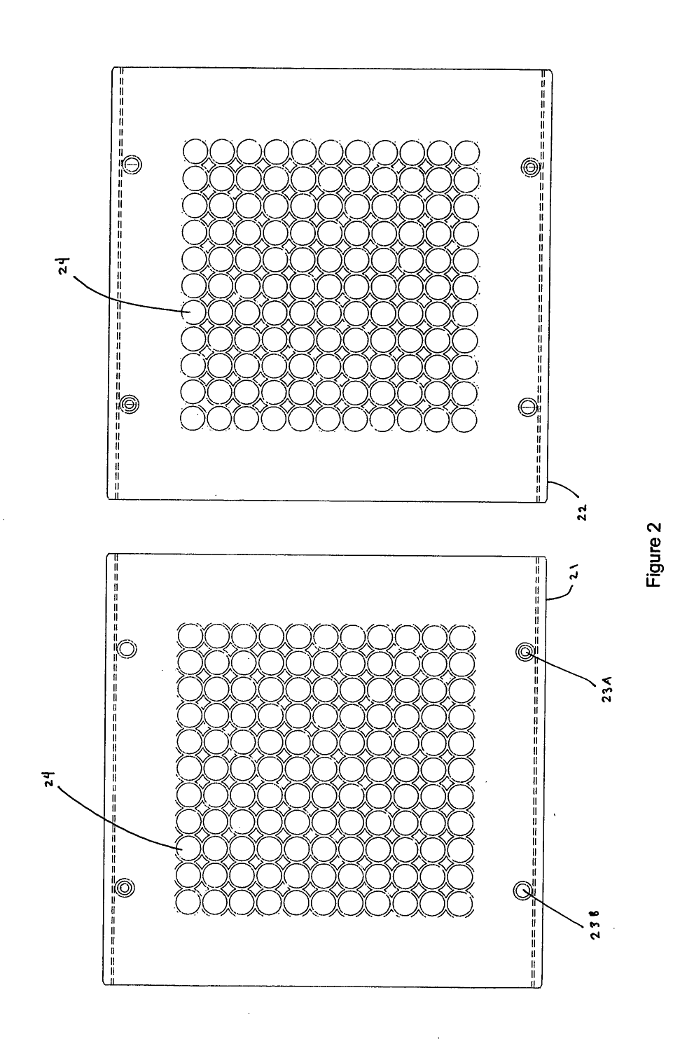

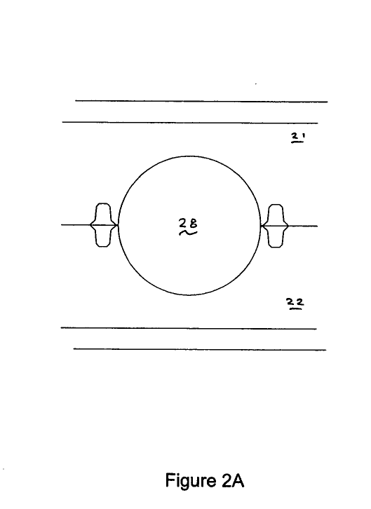

Mold 20 includes an upper mold plate 21 and a lower mold plate 22. As shown in FIG. 2, each mold plate 21, 22 contains a plurality of voids 24. These voids 24 can be used as the molding surfaces or mold cups can be placed in the cavities and used as the molding surfaces. The use of mold cups facilitates replacing the molding surfaces if they become overly worn or different mold characteristics are desired. If mold cups are used, they are retained in spaces formed in plates 21, 22 in known fashion, such as by including lips for keying the cups into mold plates 21, 22. Mold plates 21, 22 may include alignment pins 23A and bushings 23B for ensuring proper alignment during molding.

Voids 24 are disposed in a closely packed arrangement. A closely packed arrangement is preferred because it enables a maximum number of products to be molded in a press and mold of predetermined size, thus increasing productivity and reducing energy consumption. When mold plates 21 and 22 are aligned, each of voids 24 of upper mold plate 21 align with a corresponding void 24 of lower mold plate 22 to form a mold volume 28. Material to be molded is placed within volumes 28, and mold plates 21, 22 are closed together in known fashion.

FIG. 2A shows a partial side, cross-sectional view of mold plates 21, 22 in a closed position. Mold plates 21 and 22 are held in opposing abutment during the molding operation. Corresponding molding surfaces cooperate to form mold volumes 28.

The material molded within volumes 28 is preferably a golf ball product. As used herein, golf ball product means a golf ball at any stage of manufacture. This includes, for example, a core, a core and intermediate layer, or a core with an intermediate layer and a cover. If machine 10 is used to produce cores, a slug of material is placed within each volume 28 to be used and the mold plates 21, 22 are closed. If machine 10 is used to produce intermediate layers or covers, corresponding half-shells are placed within each void 24 to be used, a core or other golf ball product is placed within one of the half-shells, and the mold plates 21, 22 are closed. If machine 10 is used to produce covers on a golf ball product, the molding surfaces of volumes 28 will likely be provided with a dimple-producing pattern of protrusions in known fashion.

Once the material(s) to be molded is positioned and mold 20 is closed, pressure and heat are typically applied to voids 24. The thermal treatment applied may be constant or varied, and may include several steps of raising or lowering voids 24 to predetermined temperatures and maintaining voids 24 at those temperatures for predetermined amounts of time. In this manner, heat is transferred to or removed from volumes 28 and, therefore, the material being molded.

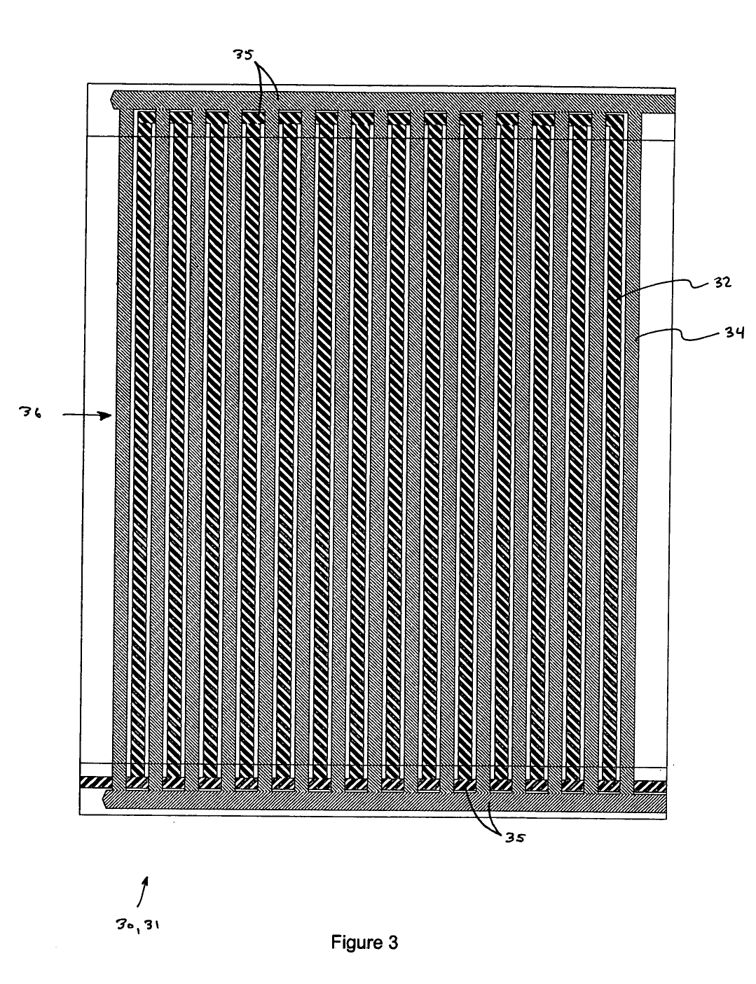

To control the temperature of the material being molded, thermal platens 30, 31 are provided. FIG. 3 shows a top view of thermal platens 30, 31. Upper thermal platen 30 is coupled to upper mold plate 21, and lower thermal platen 31 is coupled to lower mold plate 22. These couplings can be either fixed or removable. Each thermal platen 30, 31 is provided with a first series of bores or channels 32 and a second series of bores or channels 34. Channels 32, 34 provide passageways to introduce heat transfer media through platens 30, 31 to heat or cool voids 24. See U.S. Pat. Nos. 4,757,972 and 5,368,800, which are incorporated herein by reference, for a further description of heat transfer channels. Upper thermal platen 30 and lower thermal platen 31 are substantially identical. For purposes of the following discussion, only platen 30 will be discussed. However, it should be understood that the discussion applies equally to platen 31.

Each series of channels 32, 34 includes main feeder channels 35 running along opposing edges of thermal platen 30 and a plurality of transverse channels 36 running between feeder channels 35 of the respective series 32, 34. Transverse channels 36 may be arranged in a parallel fashion or in a serpentine fashion. Transverse channels of the respective series 32, 34 could be arranged the same (that is, both parallel or both serpentine), or they could be arranged differently (that is, one parallel and one serpentine). In a serpentine channel series arrangement, all of the medium flows through one transverse channel 36 in one direction, through an adjacent transverse channel 36 of the respective series in an opposite direction, through the next transverse channel 36 of the respective series in the first direction, and so on. In a parallel channel series arrangement, the medium is divided and flows through all of transverse channels 36 of the respective series simultaneously in one direction. Liquid heat transfer media are typically run through a serpentine channel arrangement, since a serpentine flow path facilitates a turbulent flow and enhances heat transfer from liquid heat transfer media at relatively low flow rates. Steam is typically run through a parallel channel arrangement because the short distance from feeder channels 35 is optimal, since steam condenses as it cools, which draws more steam into the channel.

Each end of transverse channels 36 is in fluid communication with the respective feeder channels 35. Channels 35, 36 of series 32 are separate from channels 35, 36 of series 34. Thus, a fluid introduced into series 32 will only flow through the channels 35, 36 of that series, and a fluid introduced into series 34 will only flow through the channels 35, 36 of that series. The separation of channels 32, 34 allow radically different heat transfer media to be used.

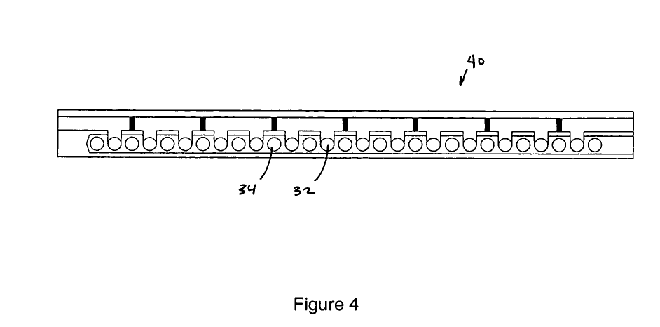

Transverse channels 36 of series 32 and 34 are substantially coplanar and parallel. The offset between series 32 and series 34 is preferably less than about one diameter of the bores of channels 36, and more preferably less than about one-half diameter of the bores of channels 36. Thus, transverse channels 36 of series 32 and 34 are vertically offset from each other from a maximum of the length of one diameter of the bore of channels 36 to a minimum of zero (no offset). The diameter of the bores of transverse channels 36 are those typically used, and may range from about 0.25 inch to about 2 inches. The size of transverse channels 36 of series 32, 34 are preferably the same, but may be different. If different, the amount of offset is based on the larger diameter. Coplanar channels 36 allow the thickness of platens 30, 31 to be kept to a minimum. This keeps the thermal mass of system 10 to a minimum, which increases the efficiency of the thermal process. Thin platens 30, 31 also places the thermodynamic media closer to the material being molded, which also makes the molding process quicker and more efficient. In order for all of transverse channels 36 to be coplanar and separated, feeder channels 35 of at least one series 32, 34 are not coplanar with transverse channels 36. FIG. 4 shows a front sectional view of an adapter 40. In the illustrative embodiment, feeder channels 35 of series 32 are substantially coplanar with transverse channels 36, and feeder channels 35 of series 34 are located above feeder channels 35 of series 32. However, the shown positions of feeder channels 35 of series 32, 34 could be reversed.

This design allows differing heat transfer media to be used simultaneously or sequentially in adjacent time intervals within thermal platens 30, 31 independently, without mixing. For example, thermal platens 30, 31 may be heated by running hot oil through channels 32 while thermal platens 30, 31 are heated by running steam through channels 34. As an alternate example, steam can be run through channels 34, and then immediately afterward cooling water run through channels 32. Exemplary heat transfer media include, but are not limited to, steam, electrical heaters, water, oil, air, and the like. The heat transfer media may be used to add heat to mold 20 or to remove heat from mold 20. By using multiple heat transfer sources, machine 10 achieves regular thermal cycles. The independent nature of channels 32, 34 of this design provides an additional benefit of rapid changes in thermal treatment by allowing, for example, a heat-adding transfer medium to be connected to one channel series and a heat-removing medium to be connected to the other channel series. The heat-adding medium could be run through its channels and turned off after a predetermined amount of time, and then the heat-removing medium could immediately be run through its channels. This increases the efficiency of the molding process by, for example, eliminating the need to connect and disconnect multiple heat transfer media to a single set of channels in the heat transfer platen and allowing more precise thermodynamic control of the molding process.

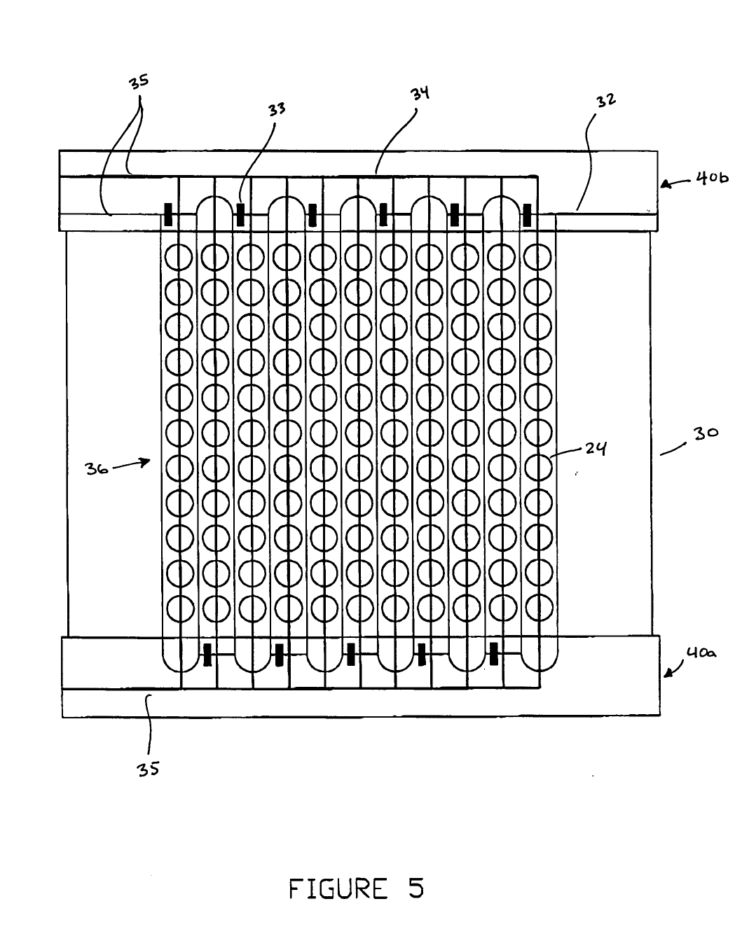

FIG. 5 shows a superposition of mold plates 21, 22 on thermal platens 30, 31. In the illustrated embodiment, series 34 transverse channels 36 run along an axis substantially aligned to a row of voids 24, and series 32 transverse channels 36 are offset from the rows of voids 24. Alternatively, series 32 transverse channels 36 could be substantially aligned to a row of voids 24, or both series 32 and series 34 transverse channels 36 could be offset from the rows of voids 24.

The flow paths through channels 32, 34 may be controlled by plugs 33. FIG. 5, for instance, illustrates that the plugs 33 may be disposed in channel 32 to provide a serpentine flow path for the heat transfer media. One benefit of using plugs 33 is that the direction of flow can be easily modified or changed as desired. For instance, the plugs 33 may be removed or opened to provide for parallel flow instead of serpentine flow of the heat transfer media through channel 32. Likewise, one skilled in the art would recognize that plugs 33 also may be disposed in other channels, including channel 34, to also control the pathway in which the heat transfer media flows. Thus, plugs may be used with flow of channel 34 to change the flow from parallel to serpentine.

Plugs 33 may be positioned around each branch of channels 32, 34. Plugs 33 also may be disposed in platens 30, 31 within threaded bores. Seals may be provided to ensure there are no leaks around plugs 33. Each plug 33 may be engaged in known manner to move it into or out of its platen 30, 31. The plug bores are aligned with channels 32, 34 and positioned such that plugs 33 will enter and pass through channels 32, 34 when threadably engaged into platens 30, 31. The diameter of plugs 33 is sized such that plugs 33 can completely fill channels 32, 34, thereby blocking or preventing flow therethrough. Each plug 33 can be positioned in an open position to allow flow through the respective channel, or a closed position to prevent flow through the channel. Only flow-blocking plugs 33 are shown in FIG. 5.

When a heat transfer medium is provided in channels 32, 34, it adds heat to or removes heat from thermal platen 30, 31. Since thermal platens 30 and 31 are coupled to mold plates 21 and 22, respectively, the heat transfer medium transfers heat to or from mold plates 21, 22. This causes heat to be added to or removed from voids 24 and the material being molded in volumes 28.

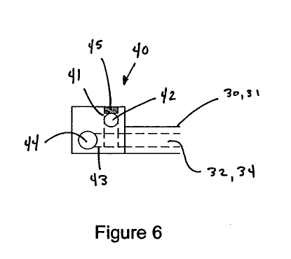

Adapter 40 is coupled to thermal platens 30, 31 at each end of channels 32, 34. FIG. 6 shows a side view of adapter 40. Adapter 40 has an orifice 42 for introducing heat transfer media into channel 32, and an orifice 44 for introducing heat transfer media into channels 34. Orifices or feed ports 42, 44 are made by drilling a series of bores 41, 43 in adapter 40. A plug 45 may be provided to maintain fluid integrity of adapter 40 or to allow for reconfiguring flow. Bores 41, 43 are independent and do not intersect so that heat transfer media can be introduced independently without mixing. Heat transfer media may be introduced into either of feed ports 42, 44 independently of the other feed port 42, 44. Adapter 40 allows each of a plurality of heat transfer media to be isolated, stored separately, and maintained at a predetermined temperature.

Fluid heat transfer media may be stored and maintained at predetermined temperatures in a reservoir (not shown). Electric heaters or coolers may be used in known fashion to maintain the media at the desired temperature(s). The heaters and coolers may simply be on-off types, or there may be some control loop to maintain the storage temperature within the reservoirs. These heat transfer media are preferably connected to adapter 40 by flexible hoses (not shown). Flexible hoses are preferred because they help protect molding machine 10 from thermal shock and water hammer. Flexible hoses are additionally beneficial because they do not hinder movement of the platens or mold plates.

If a non-flowable medium, such as an electric heater, is used, it is placed within the desired channels 32, 34 and operated in known fashion.

In use, heat transfer media will be introduced by at least one of orifices 42, 44 into the corresponding feeder channel 35. The heat transfer media will flow through feeder channel 35 to and through transverse channels 36. After exiting transverse channels 36, the heat transfer media will flow through the same or the other feeder channel 35 and exit molding machine 10 by the same or by another adapter 40. From here, the heat transfer media can be discarded or returned to a holding vessel to be heated or cooled and recycled through molding machine 10.

The flow through channels 34 is a parallel flow in the illustrated embodiment of FIG. 5. A heat transfer medium enters channels 34 by adapter 40b. The medium flows through feeder channel 35 and across through each of transverse channels 36 simultaneously in the same direction (top to bottom in FIG. 5). After crossing through transverse channels 36, the medium enters the other feeder channel 35 and flows out of platen 30, 31 through adapter 40a.

The flow through channels 32 is a serpentine flow in the illustrated embodiment of FIG. 5. A heat transfer medium enters channels 32 by adapter 40b. The medium flows down feeder channel 35, across through one of transverse channels 36, down the other feeder channel 35 to the next transverse channel 36, across that transverse channel 36, and so on. Plugs 33 are arranged to cause the medium to flow in opposite directions through adjacent transverse channels 36. After flowing through channels 32, the medium exits platen 30, 31 by either adapter 40a or 40b.

While flowing through channels 32, 34, heat addition to or removal from the medium will cause a temperature difference within the medium between the entry into and exit from platen 21, 22. This temperature difference will increase as the flow path distance increases. The temperature difference is controlled by the flow rate of the heat transfer media. By minimizing the temperature difference, more of platen 20, 21 is treated with media of the desired temperature and heat transfer to or from the material being molded is enhanced. The temperature difference between a medium entering and exiting platen 20, 21 is preferably less than or equal to 10° F. More preferably, this temperature difference is less than or equal to 5° F.

As an exemplary thermal treatment process, heat-adding transfer media, such as steam, can be run through orifice 44 into and through channels 34 to maintain platens 30, 31 (and, therefore, the materials being molded) at a predetermined, elevated temperature. After a predetermined amount of time, the flow through orifice 44 is terminated, and flow of a heat-removing transfer media, such as water, is run through orifice 42 into and through channels 32. This may allow the temperature of platens 30, 31 to be reduced to a second predetermined temperature. After a predetermined amount of time, mold 20 can be opened and the molded products removed therefrom. Virtually any thermal treatment regimen may be applied by selecting the appropriate heat transfer media, temperatures, flow rates, and flow direction. If a liquid heat transfer medium, such as water, is used to cool the platen, the channels 32 or 34 through which this medium flows are preferably substantially drained or flushed out, for example by compressed air, prior to another heat transfer medium being transmitted through channels 32, 34 to heat the platen. This will help the efficiency of the system, since, for example, heat could be wasted by being absorbed by the liquid and converting it to vapor instead of being transferred to the material being molded.

While the present invention is illustrated by the embodiments described herein, a skilled artisan would recognize that the invention is not limited strictly to these examples or illustrations. For instance, more than two channels may be utilized to provide additional heating or cooling sources. A third channel may be used, for example, to provide additional heating using heat cartridges, hot oil, or steam. Likewise, four or more channels also may be used to further permit customized heating and/or cooling of the platen.

A feedback control loop (not shown) may be used with molding machine 10. Such a control loop may include a device for measuring the temperature of platen 30, 31 and/or mold plate 21, 22. This control system may also be coupled to the heat transfer media control system so that flow rates or temperatures can be adjusted to achieve the desired plate temperature. The system can also be operated manually, with or without a feedback system.

Preferred uses for molding machine 10 include dual core processes, laminate molding, and plastic compression molding. However, molding machine 10 may also be used with other ball forming methods.

Lower mold plate 22 and lower heat transfer platen 31 are coupled to a moving press platen 51. Upper mold plate 21 and upper heat transfer platen 30 are coupled to head 50. In use, ram 52 is lowered or moved away from head 50 and the material to be molded is loaded into molding machine 10 as described above. After the material has been loaded, ram 52 is engaged and platen 51 and mold plate 22 are raised to the molding position. Ram 52 is moved in conventional fashion, such as by hydraulics.

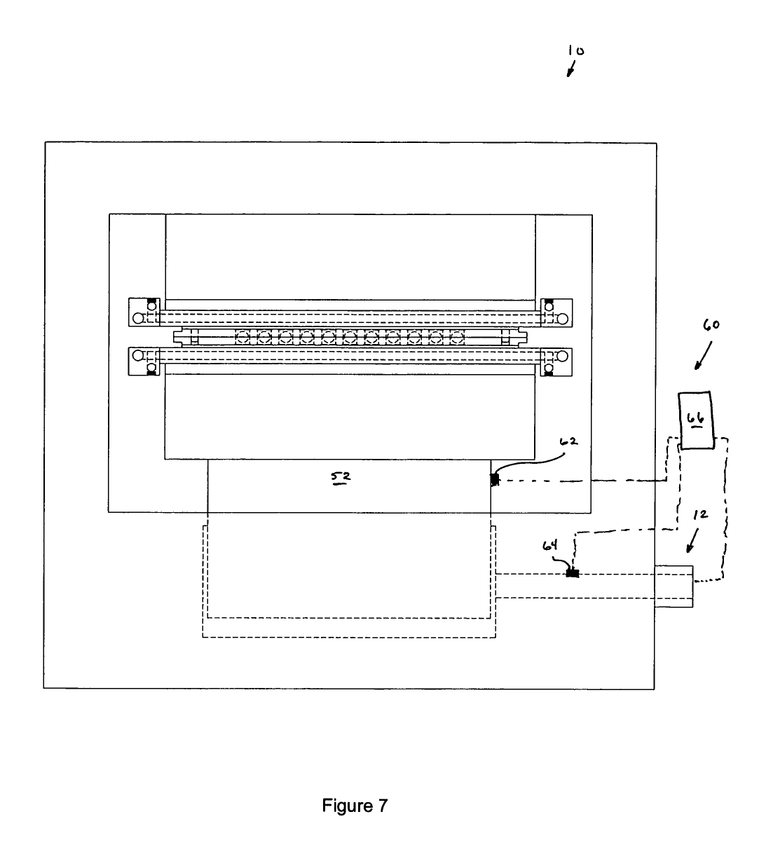

Molding machine 10 may be fitted with a mold protection device to ensure mold plates 21, 22 close in a safe and efficient manner. FIG. 7 shows a mold protection device 60 installed on a molding machine 10 of the present invention. A control system 12 controls movement of ram 52. Protection device 60 includes a linear measurement device 62 connected to ram 52. Device 62 emits a signal corresponding to its linear position. Since device 62 moves with ram 52, the signal it emits also corresponds to the position of ram 52, which can be used to determine the positions of press platen 51, heat transfer platen 31, and mold plate 22. Device 62 is preferably a linear transducer.

Protection device 60 includes a pressure measurement device 64. Device 64 emits a signal corresponding to the pressure exerted thereon. Device 64 is coupled to a ram control system 12 so as to determine the pressure exerted on ram 52 by control system 12. Control system 12 is preferably a hydraulic control system. Therefore, the signal device 64 emits also corresponds to the pressure exerted by ram 52, which corresponds to the pressure between mold plates 21 and 22. Device 64 is preferably a pressure transducer.

The signals emitted by devices 62, 64 are transmitted to a protection device controller 66. The signals may be transmitted by any known means, including wired and wireless transmission means. Controller 66 allows the user to perform such functions as, but not limited to: monitoring the position of the moving mold plate(s), monitoring the pressure exerted by ram 52 or between mold plates 21, 22, setting limit alarm and shut-off values, and performing an emergency stop to the molding process.

As mold machine 10 closes, it is monitored by system 60. Device 62 constantly measures the position of ram 52 and device 64 constantly measures the pressure imposed on or by ram 52. From the full open position, ram 52 must be engaged a relatively long distance for mold plates 21, 22 to mate and be retained in the molding position. Thus, it is desirable to move ram 52 relatively quickly. However, when plates 21, 22 are near and about to mate, it is desirable to move ram 52 relatively slowly. This ensures plates 21, 22 are not slammed together, which could cause injury to personnel and damage the equipment. Thus, there is a first height trigger at which the speed of ram 52 is decreased.

This first height trigger is based on the position of ram 52. When moving from the full open position, where ram 52 is fully withdrawn or lowered away from head 50, ram 52 is initially moved at a relatively fast speed to decrease the plate movement time and to increase the efficiency of the molding process. Upon reaching a predetermined height, the speed of ram 52 is decreased, allowing for safe coupling of mold plates 21, 22. The first height trigger is preferably set so that the speed decrease occurs when mold plate 22 is a distance of approximately two plate thicknesses away from mold plate 21. More preferably, the first height trigger is set to trip at a distance of one and a half plate thicknesses, and most preferably at a distance of one plate thickness. The distance may also be characterized by absolute measurements. In order of increasing preference, the first height trigger can be set to trip at distances of two inches, one and a half inches, and one inch away from the molding position. The relatively fast speed is preferably about one inch per second, and the relatively slow speed is preferably about one inch per minute.

The first height trigger is variable. Based on the particular operation of machine 10, the first height trigger must be set at different heights of ram 52. For example, if machine 10 is being used to form dual cores, which entails molding two half-shells around a center, only two plates are used; the center is placed between two half-shells, and the three items are compressed between two plates. However, if machine 10 is used to produce the half-shells, three plates are used; one slug of shell material is placed in voids 24 of a first plate, a second plate having protrusions on both sides of the same dimension as half of the center is placed atop the first plate, and a third plate having half-shell slugs in voids 24 is loaded face-down atop the second plate. The three plate arrangement is thicker than the two plate arrangement, so the slow-down trigger is variable to allow the longest amount of fast-speed movement of ram 52. That is, the first height trigger is variably set to trip at different heights or amounts of extension of ram 52. Yet another trip height may be preferable when forming the centers. Note that when slugs (rather than half-shells and centers) are being compressed, they may initially be resistant to compression, creating separation between and additional thickness to the plates. Finally, a double-mold arrangement, which uses two molds 20 that each include two or three mold plates, may be used with machine 10, creating multiple additional permutations of plate thicknesses and settings for the first height trigger.

Device 64 continuously monitors the pressure being exerted by ram 52. Before reaching the height at which the first height trigger is tripped, there should be nothing contacting the plate(s) resting on ram 52. Therefore, the only pressure exerted by ram 52 should be that required to raise the weight of the plate(s) and materials to be compressed. During the time before the first height trigger is tripped, machine 10 is set to stop if the pressure exerted by ram 52 exceeds a first pressure trigger. The first pressure trigger is preferably about 110% of the weight being lifted by ram 52. More preferably, the first pressure trigger is about 105% of the weight being lifted by ram 52. Most preferably, the first pressure trigger is about 102.5% of the weight being lifted by ram 52.

After the first height trigger has been tripped and the speed of ram 52 has decreased, the point at which mold 20 contacts upper heat transfer platen 30 is approached. At this contact point, movement of ram 52 will be resisted and the pressure exerted on mold plates 21, 22 will increase to ensure that they will be held together during the molding process. A second height trigger is set to trip at a predetermined height of ram 52, at which there is a predetermined distance between mold 20 and platen 30. That is, the second height trigger is set to trip when there is a predetermined amount of travel for ram 52 prior to the contact point. The second height trigger is preferably set so that the possibility of a foreign object, such as a tool or body part, being between the moving and static parts of machine 10 is minimized prior to the second height trigger being tripped. That is, the second height trigger is set to trip just prior to the contact point so that the space between mold 20 and platen 30 is small enough that the likelihood of any foreign object fitting therebetween is extremely small. This enhances the safety of the molding process. The second height trigger is preferably set to trip at a distance of 0.5 inch prior to the contact point. More preferably, the second height trigger is set to trip at a distance of 0.25 inch prior to the contact point. Most preferably, the second height trigger is set to trip at a distance of 0.125 inch prior to the contact point.

The second height trigger tells system 60 that an increased pressure on ram 52 is expected. Thus, a second pressure trigger is engaged simultaneously with the second height trigger. The second pressure trigger is set to trip if the expected molding pressure is exceeded. Thus, if for some reason the pressure on ram 52 is increased to a value greater than the maximum molding pressure, the second pressure trigger trips, causing the molding process to stop and ram 52 to lower. Typical molding pressures above which the second pressure trigger will be set include about 200 psi, about 1000 psi, and about 2000 psi.

A third height trigger is set to trip at a height above which the contact point should occur. If for some reason ram 52 continues to move upward past the expected contact point, the third height trigger is tripped, engaging a third pressure trigger. The third pressure trigger is set to trip if the pressure on ram 52 exceeds a safe amount, and is preferably set to be the same as the first pressure trigger. Thus it is seen that the only heights at which an elevated pressure is acceptable is between the second and third height triggers. If an elevated pressure is experienced at any other time, one of the pressure triggers will engage to stop the molding process and lower ram 52. The third height trigger is preferably set to trip at a distance of about 0.25 inch to about 12 inches above the expected contact point. More preferably, the third height trigger is set to trip at a distance of about 1 inch to about 6 inches above the expected contact point.

A fourth height trigger is set to trip at a height above which additional extension of ram 52 is dangerous. The fourth height trigger is intended to ensure that ram 52 is not engaged so far that it is extended out of its mountings or contacts an upper support structure, such as a ceiling. It is envisioned that ram 52 will only be extended so far as to trip the fourth height trigger during periods of maintenance or testing when there may be no head 50 in place. The fourth height trigger is preferably set to trip at 80% of the maximum travel of ram 52. More preferably, the fourth height trigger is set to trigger at 70% of the maximum travel of ram 52. If the fourth height trigger is tripped, system 60 will stop the molding process and lower ram 52 regardless of the system pressure.

Each of the triggers are variable and may be altered by the user. System 60 continuously monitors molding machine 10 and continuously provides information to controller 66. In this manner, protection device 60 protects machine 10 from damage that would occur, for example, if the mold were accidentally closed on an incompressible object. Additionally, the operator can monitor the measured information to determine the extent of any cycle-to-cycle variations, thus allowing the operator to more accurately control the molding process. Controller 66 may be a variable control system, and may comprise a programmable logic controller (PLC). Controller 66 is coupled to and operates ram control system 12.

While the preferred embodiments of the present invention have been described above, it should be understood that they have been presented by way of example only, and not of limitation. It will be apparent to persons skilled in the relevant art that various changes in form and detail can be made therein without departing from the spirit and scope of the invention. Thus the present invention should not be limited by the above-described exemplary embodiments, but should be defined only in accordance with the following claims and their equivalents.

1. A molding machine, comprising:
a mold, including an upper mold plate and a lower mold plate, said upper mold plate and having a first plurality of cavities therein and said lower mold plate and having a second plurality of cavities therein, said first and second pluralities of cavities cooperating to form a plurality of mold volumes when said first and second mold plates are aligned and abutted;
an upper heat transfer platen coupled to said upper mold plate, said upper heat transfer platen having a first series of channels and a second series of channels, said first series of channels being separate from said second series of channels, wherein said first and second series of channels are substantially coplanar within said upper heat transfer platen; and
a lower heat transfer platen coupled to said lower mold plate, said lower heat transfer platen having a third series of channels and a fourth series of channels, said third series of channels being separate from said fourth series of channels, wherein said third and fourth series of channels are substantially coplanar within said lower heat transfer platen.

2. The molding machine of claim 1, wherein:
said first series of channels includes a first feeder channel and a second feeder channel running along opposing edges of said upper heat transfer platen and a first plurality of transverse channels connecting said first and second feeder channels;
said second series of channels includes a third feeder channel and a fourth feeder channel running along opposing edges of said upper heat transfer platen and a second plurality of transverse channels connecting said third and fourth feeder channels;
said third series of channels includes a fifth feeder channel and a sixth feeder channel running along opposing edges of said lower heat transfer platen and a third plurality of transverse channels connecting said fifth and sixth feeder channels; and
said fourth series of channels includes a seventh feeder channel and an eighth feeder channel running along opposing edges of said lower heat transfer platen and a fourth plurality of transverse channels connecting said seventh and eighth feeder channels.

3. The molding machine of claim 2, wherein said first and second series of channels are disposed within an adapter in communication with the upper heat transfer platen.

4. The molding machine of claim 3, wherein:
said adapter comprises a first and second orifice;
said first orifice provides fluid communication from a first source of a first heat transfer medium to said first series of channels;
said second orifice provides fluid communication from a second heat transfer medium to said second series of channels; and
said adapter is capable of independently supplying said first and second heat transfer media to the first and second series of channels.

5. The molding machine of claim 4, wherein said two heat transfer media are selected from a group consisting of steam, electrical heaters, water, oil, air, and the like.

6. The molding machine of claim 4, wherein said two heat transfer media include a medium to add heat and a medium to remove heat.

7. The molding machine of claim 2, wherein:
said first and second pluralities of transverse channels are vertically offset by a maximum of about one times a diameter of said first plurality of transverse channels; and
said third and fourth pluralities of transverse channels are vertically offset by a maximum of about one times a diameter of said third plurality of transverse channels.

8. The molding machine of claim 2, wherein:
said first and second pluralities of transverse channels are substantially coplanar; and
said third and fourth pluralities of transverse channels are substantially coplanar.

9. The molding machine of claim 2, wherein:
said first plurality of transverse channels are relatively substantially parallel, said second plurality of transverse channels are relatively substantially parallel, and said first plurality of transverse channels are substantially parallel to said second plurality of transverse channels; and
said third plurality of transverse channels are relatively substantially parallel, said fourth plurality of transverse channels are relatively substantially parallel, and said third plurality of transverse channels are substantially parallel to said fourth plurality of transverse channels.

10. The molding machine of claim 1, further comprising a ram coupled to said lower heat transfer platen.

11. The molding machine of claim 10, further comprising a plurality of thermal insulation plates.

12. The molding machine of claim 11, wherein at least a portion of said thermal insulation plates are intermediate said ram and said lower heat transfer platen.

13. The molding machine of claim 10, further comprising a control system for controlling movement of said ram.

14. The molding machine of claim 1, further comprising a mold protection device for monitoring the operation of the molding machine.

15. The molding machine of claim 14, wherein said protection device includes a linear measurement device.

16. The molding machine of claim 14, wherein said protection device includes a pressure measurement device.

17. The molding machine of claim 14, wherein said protection device includes a linear measurement device and a pressure measurement device.

18. A compression molding machine, comprising:
a movable ram;
a static head; and
a protection system.

19. The molding machine of claim 18, wherein said protection system includes:
a linear measurement device for measuring a position of said ram;
a pressure measurement device for measuring a pressure exerted by said ram; and
a controller coupled to said linear measurement device and pressure measurement device.

20. The molding machine of claim 19, wherein said controller contains a plurality of programmable triggers to ensure the molding machine is operated in a safe manner.

21. The molding machine of claim 20, wherein engagement of one of said variable triggers disengages said ram.

22. The molding machine of claim 20, wherein said plurality of triggers are based on measurements from said linear measurement device or said pressure measurement device.

23. The molding machine of claim 20, wherein said plurality of triggers are based on measurements from said linear measurement device and said pressure measurement device.

24. The molding machine of claim 20, wherein said controller contains a variable trigger for transitioning between a first ram speed and a second ram speed, said first ram speed being faster than said second ram speed.

25. The molding machine of claim 20, wherein said controller contains a variable trigger for disengaging said ram if a measurement from said pressure measurement device exceeds a predetermined value.

26. The molding machine of claim 20, wherein said controller contains a variable trigger for transitioning between a relatively low pressure limit and a relatively high pressure limit.

27. The molding machine of claim 26, further including a second variable trigger for disengaging said ram if a measurement from said pressure measurement device exceeds said relatively high pressure limit.

28. The molding machine of claim 26, wherein said controller contains a second variable trigger for transitioning between a relatively high pressure limit and a relatively low pressure limit.

29. The molding machine of claim 28, further including a third variable trigger for disengaging said ram if a measurement from said pressure measurement device exceeds said relatively low pressure limit.

30. The molding machine of claim 20, wherein said controller contains a variable trigger for limiting the maximum extension of said ram.

31. The molding machine of claim 20, wherein engagement of said variable trigger disengages said ram.

32. The molding machine of claim 18, wherein said protection system is operatively coupled to said ram and controls movement of said ram.

33. The molding machine of claim 32, wherein said protection system extends said ram at a plurality of speeds.

34. The molding machine of claim 33, wherein said plurality of speeds include:
a first speed for moving said ram from a withdrawn position; and
a second speed for moving said ram into a molding position.

35. The molding machine of claim 34, wherein said first speed is faster than said second speed.

36. The molding machine of claim 33, wherein said plurality of speeds include:
a first speed of about one inch per second; and
a second speed of about one inch per minute.

37. A molding machine, comprising:
a heat transfer platen having a first series of channels and a second series of channels, said first series of channels being separate from said second series of channels, wherein said first and second series of channels are substantially coplanar within said heat transfer platen.

38. The molding machine of claim 37, further comprising a third series of channels disposed within said heat transfer platen.

39. The molding machine of claim 38, wherein said molding machine is capable of independently supplying a first heat transfer medium to said first series of channels, a second heat transfer medium to said second series of channels, and a third heat transfer medium to said third series of channels.
